(19) United States
(12) Patent Application Publication
(10) Pub. No.: US 2023/0072209 A1
(43) Pub. Date: Mar. 9, 2023

(54) SYSTEM AND METHOD FOR MOBILE ADVERTISING

(71) Applicants: Jonah Tal Tuckman, Princeton, NJ (US); Cole Richard Johnson, Princeton, NJ (US); Corin Rose, Poughkeepsie, NY (US)

(72) Inventors: Jonah Tal Tuckman, Princeton, NJ (US); Cole Richard Johnson, Princeton, NJ (US); Corin Rose, Poughkeepsie, NY (US)

(21) Appl. No.: 17/795,917

(22) PCT Filed: Dec. 18, 2020
(86) PCT No.: PCT/US2020/065880

§ 371 Date: Jul. 28, 2022

Related U.S. Application Data
(60) Provisional application No. 62/968,647, filed on Jan. 31, 2020.

(51) Int. Cl. G06Q 30/02; G09F 9/30; G09F 21/04; G06V 40/16; G06V 20/58

(52) U.S. Cl. CPC G06Q 30/0265; G06Q 30/0207; G06Q 30/0257; G06Q 30/0261; G06Q 30/0267; G06Q 30/0269; G06Q 30/0272; G06V 20/58; G06V 40/161; G09F 9/30; G09F 21/048; H04W 4/23

(57) ABSTRACT

A device and system for mobile advertisement and displaying advertisements to people outside a vehicle, and method for use thereof. The device is capable of wirelessly communicating with a separate mobile device, and utilizes one or more processors, a display screen for receiving and displaying images and/or video advertisements, a camera for capturing images of faces as the advertisement is being displayed, and a wireless communication transceiver.

### CROSS-REFERENCE TO RELATED APPLICATIONS

This application claims priority to U.S. Pat. Application No. 62/968,647 Filed Jan. 31, 2020, which is herein incorporated by reference in its entirety.

### FIELD OF THE INVENTION

The present disclosure relates to mobile advertising, and specifically to electronic micro-advertisements in or on vehicles.

### BACKGROUND

Businesses are constantly looking for new ways to reach the eyes of consumers and the general public as a whole. Cars and trucks are heavily viewed by drivers in other cars or trucks, as well as those in the general public, but most vehicles do not have any advertisements running on them right now. One issue is that in the current advertising market, the standard of billboards, bus sides, and taxi tops that can be found in cities and towns do not allow for businesses to be liquid in their advertisement. This means that industries that promote quick turnover of ads, such as movie premieres, music releases, technology releases, sports games, awards, shows, and others, do not have the ability to advertise in the short timeframes or in targeted audiences that may be more fit for their business.

Further, with the current on-vehicle advertising, neither drivers nor advertisers have control over the available ad space that a vehicle can display in terms of their GPS location.

Finally, drivers are not being properly incentivized to display advertisements - they are not compensated appropriately for the amount of visibility they provide for an advertiser. For example, on social media sites, an “influencer” will receive payments based on the number of views an ad embedded in their content receives, yet a driver who provides an advertisement with a similar number of views garner significantly less pay.

### BRIEF SUMMARY

A first aspect of the present disclosure is drawn to a display device for mobile advertisement. The display device includes a display screen, a processor, a camera, and a wireless communication transceiver. The display device is adapted to wirelessly communicate (preferably, via a low power and/or short-range wireless communication protocol such as bluetooth) with a mobile device (such as a smartphone), where the mobile device is adapted to communicate with a remote server. The display device is configured to be placed in a location within or on a vehicle such that the display screen can be seen by someone outside the vehicle. The display device may optionally include one or more sensors. Although the size of the display device can vary, the display device preferably has a diagonal viewing dimension of between 20 and 30 inches. Preferably, the processors in the display device are configured to receive an image from the camera, detect the presence of any faces in the image, and count any faces it detects, delete the image, and transmit at least the count of the one or more faces in the image to at least one remote processor (such as a mobile device it is in communication with, or to a remote server). Preferably, the display device does not continuously capture images, but rather captures an image, delays for a period of time, and then captures another image. The delay between image captures is preferably less than a second.

A second aspect of the present disclosure is drawn to an advertising system. The system includes a display device as described above and a mobile device paired to that display device. The mobile device is connected to a remote server and the display device, and is configured to run an application allowing it to receive an advertisement from the remote server, then send the advertisement to the display device. Preferably, the advertisement received from the remote server is based on filters (including filters for limiting which advertisements can be presented and/or increasing categories of advertisements that are preferred) selected by a user of the application. Preferably, the display device is operably connected to an exterior of a passenger side door of a car. Optionally, the one or more processors are configured to instruct the camera to capture one or more images while a first advertisement is being displayed on the display screen and send the one or more images to the mobile device. Optionally, the mobile device is further configured to count the number of faces present in all images captured while the first advertisement is being displayed. Optionally, the mobile device is further configured to determine if the same face is present in more than one image. Optionally, the mobile device is further configured to associate a geographic location with each face. Optionally, a user of the application can create a user profile, and the system is configured such that the advertisement received from the remote server is based on the user profile. Optionally, a user of the application can select the advertisement received from the remote server.

A third aspect of the present disclosure is drawn to a method for mobile advertising. The method includes sending a request for a first matching advertisement, receiving data that contains an advertisement to be displayed and a target number of faces, and causing a display device to display the advertisement. While the advertisement is being displayed, three things occur, a camera captures images, the number of faces in the captured images are counted, and a geographic location is associated with the faces or image. In preferred embodiments, the system assigns the same geographic location to all faces counted for a given image. The method then involves sending data comprising the counted number of faces and geographic locations of the counted faces to a remote server, and then receiving data that indicates the amount a user will be paid based on the counted number of faces. Optionally, the method also includes sending a request for a second matching advertisement when the number of counted faces is at the target number of faces ± 10%.

A fourth aspect of the present disclosure is drawn to a system that includes one or more processors (such as at a remote server), for displaying mobile advertising. The one or more processors are configured to receive a plurality of advertiser requests, each advertiser request comprising an image or video to display, a target location, and a maximum number of people that should see the image or video. The processors can then store each of the plurality of advertising requests with an associated advertising request identifier. The processors may optionally be configured to receive a user profile containing a characteristic (e.g., location, etc.) or preference (e.g., categories of types of desired advertisements, etc.) from a user from a mobile device, and store the user profile along with an associated user profile identifier. The processors are also configured to receive a user request for a matching advertisement, and determine which of the stored advertiser requests is an optimal fit for the user request, based on a characteristic or preference of a user, a user location, optional user filters, and/or the target location, and then send the image or video from the matching advertiser request to the mobile device. Optionally, the processors are also configured to receive an update from the mobile device indicating a number of faces counted and a geographic location of each face, and transfer a payment to the user based on the number of faces counted. Optionally, the processors are also configured to receive a request for the geographic distribution of counted faces for a given advertiser request and generate a heat map of the counted faces based on the geographic location received for each face.

A fifth aspect of the present disclosure is drawn to a method for displaying mobile advertising. The method involves first receiving a plurality of advertiser requests, where each advertiser request comprising an image or video to display, a target location, and a maximum number of people that should see the image or video. The requests are then stored, along with an associated advertising request identifier. The method optionally includes receiving a user profile from a mobile device (which includes a characteristic or preference), and storing the user profile and an associated user profile identifier. The method also includes receiving a user request for a matching advertisement. After receiving the request, the method involves determining which of the plurality of advertiser requests is an optimal fit for the user request, based on the user characteristic(s) and/or preference(s), a user location, user filters, and/or the target location, and sending the image or video from the optimally fitting advertiser request to the mobile device. Optionally, the method also includes receiving an update from the mobile device indicating a number of faces counted and a geographic location of each face; and transferring a payment to the user based on the number of faces counted. Optionally, the method also includes receiving a request for the geographic distribution of counted faces for a given advertiser request, and generating a heat map of the counted faces based on the geographic location received for each face.

### BRIEF DESCRIPTION OF THE DRAWINGS

FIGS. 1A and 1B are simplified illustrations of embodiments of the disclosed system.

FIG. 2 is a block diagram of an embodiment of an advertisement display device.

FIG. 3A is a flowchart describing an embodiment of an application running on a mobile device.

FIGS. 3B and 3C are flowcharts describing embodiments of an Ad Store running on a remote server.

FIGS. 4A and 4B are simplified illustrations of the display device with a mount.

FIG. 5A is an isometric view of one embodiment of a display device.

FIG. 5B is an rear view of one embodiment of a display device, including mounting brackets.

FIG. 5C is a side view of a mounting bracket.

FIG. 5D is an isometric view of a mounting block

### DETAILED DESCRIPTION

The term “image” or “images” as used herein refers to any digital representation comprising an image, where the digital representation can be stored on a non-transitory computer readable medium. An “image” can include a still or animated image stored in a known image file format (e.g., .jpg, .gif, .png, .tif, etc.) or video stored in a known video file format (e.g., .mp4, .mov, etc.).

The disclosed system and method solve the three problems experienced by the current advertising technology. The system provides a new space for a company to run advertisements on, to put their message out into the general public, as well as adding links (e.g., via 1D or 2D bar codes) to their websites to increase the foot traffic their products and ideas are receiving. The system and method provide drivers and advertisers with the ability to control the ad space displayed on a vehicle as well as to monetize this space based on its value and location. And the system and method allow for the monetization of vehicle space that does not exist right now, by creating a way for people to add passive income and monetization strategies for their space, that does not include the hope of becoming viral, while also getting maximum views on an advertisers specific ad.

The present disclosure is drawn to a software and hardware display device, system, and methods of use for mobile advertisements.

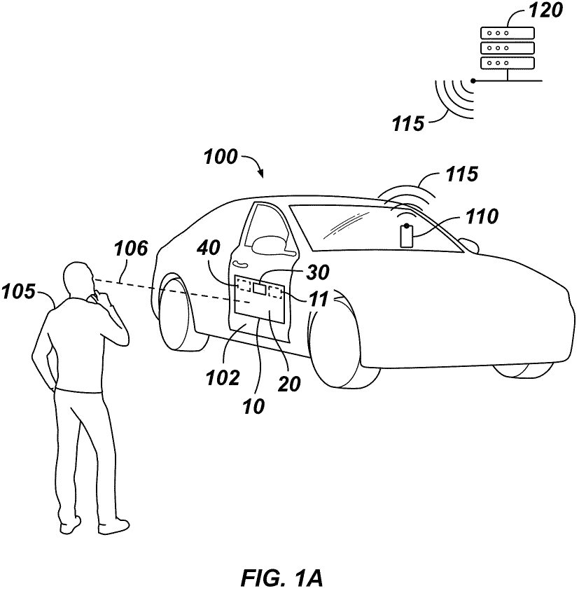

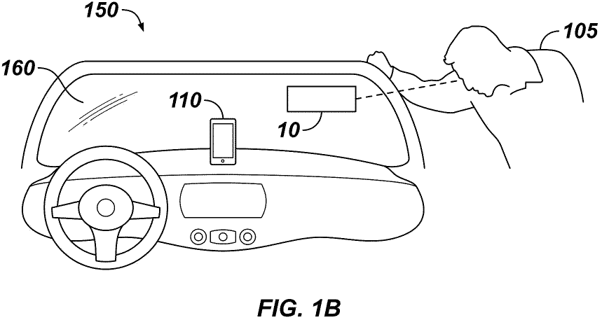

Preferred embodiments of the devices and systems disclosed herein can best be understood with reference to FIGS. 1A and 1B.

Referring to FIG. 1A, a preferred system (100) generally includes a remote server (120) where advertisers can submit and store their ads, to be displayed by the disclosed system. A driver’s mobile device (110) communicates wirelessly (115) with the remote server, receiving information about an ad (or multiple ads, such as a “playlist” of ads) to be displayed, either continuously, or where each ad in a group of multiple ads is displayed for a fixed period of time (typically less than 1 minute, such as 5 seconds, 10 seconds, 15 seconds, 20 seconds, or 30 seconds). The mobile device then sends an image to be displayed to a display device (10) that is removably attached to the driver’s vehicle (101), such as to an outside surface (102) of a passenger door of the vehicle. The display device contains a display screen (20), a camera (30), one or more processors (11) and a wireless communications interface (40). The display device is configured to be placed in a location within or on a vehicle such that the display screen can be seen (106) and read by a person (105) outside the vehicle (such as a pedestrian, a person in a different vehicle, etc.). The display device receives the ad information from the mobile device, and displays it. While displaying, it captures images, identifies faces in each image, and counts the faces. Periodically, the device sends a count of faces back to the smartphone, preferably along with a code identifying at least one location where the image(s) used to count face(s) was captured, such as a GPS location. The mobile phone can then take that count, and periodically send data back to the remote server indicating the number of faces counted for a given advertisement, which allows the remote server to determine the pay the driver should receive. The remote server can also provide various analytics, etc., for users and/or advertisers.

As will be understood by those of skill in the art, the display device may be placed in other locations than the side of a door, including, e.g., a bumper, hood, or inside or outside a window. For example, referring briefly to FIG. 1B, the display device (10) may be positioned in the interior of a vehicle, attached to the front windshield (160) of a vehicle, such that a person (105) outside the car can see the display device (10), and specifically the display screen (not shown) through the windshield (160).

Various components of the system are described below.

### Display Device

The display device is adapted to wirelessly communicate with a mobile device. In operation, the display device is configured to be placed in a location within or on a vehicle (including, e.g., a bicycle, motorcycle, automobile, truck, or boat), such that the display screen can be seen and read by a person outside the vehicle.

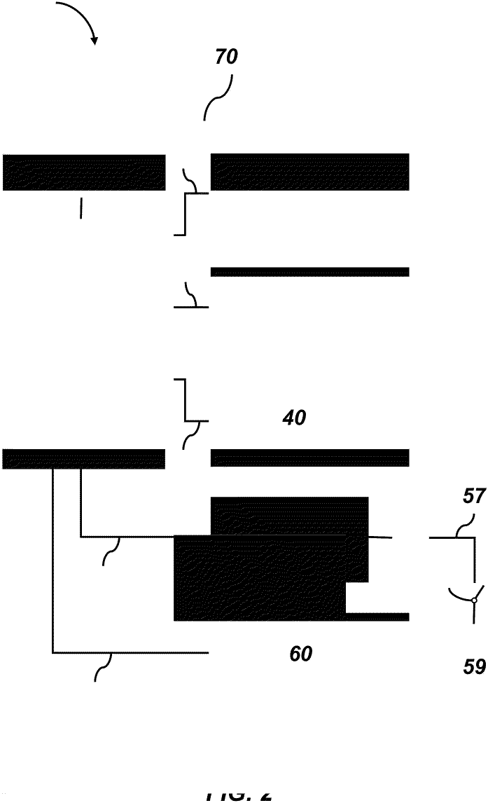

The components of the display device can more easily be understood with reference to FIG. 2. As seen in FIG. 2, the display device (10) will contain one or more processors (11), which control the operation of the display device (10). The display device will also include a display screen (20), a camera (30), a wireless communication transceiver (40), power circuitry (50), and optional components (60), and will have some form of outer housing (70).

In some embodiments, the device will comprise, consist essentially of, or consist of the display screen, processor, memory, camera, one or more wireless communication transceivers, power circuitry, optional indicators, optional additional sensor, optional data communication ports, and optional GPS, as well as housing which may optionally include venting ports and/or mounting brackets.

### Processors

The display device (10) will contain one or more processors (11). In some embodiments, the one or more processors (11) may be part of a single-board computer, such as a Raspberry Pi. In some embodiments, the one or more processors may be stand-alone processor chips.

The display device (10) will typically also include memory (12), which is operably connected to the one or more processors (11). The memory may be volatile, non-volatile, or a combination thereof. While any amount of memory may be present, the amount of memory required may by less than or equal to 1 GB. In some embodiments, the amount of memory required may be between 1 GB and 16 GB of memory.

In preferred embodiments, the one or more processors are configured to assist in the process of determining how many people have seen the displayed advertisement. That is, the one or more processors are configured to first receive an image from the camera. The processors are configured to process the image using facial detection routines, which detect one or more faces in the image using known facial detection techniques. Such techniques can include edge-orientation matching (see, e.g., Fröba, Küblbeck: Audio- and Video-Based Biometric Person Authentication, 3rd International Conference, AVBPA 2001, Halmstad, Sweden, June 2001. Proceedings, Springer. ISBN 3-540-42216-1), Hausdorff Distance-based face localization (see, e.g., Jesorsky, Kirchberg, Frischholz: Audio- and Video-Based Biometric Person Authentication, 3rd International Conference, AVBPA 2001, Halmstad, Sweden, June 2001. Proceedings, Springer. ISBN 3-540-42216-1), Weak classifier cascades (e.g., using a viola-jones object detection framework), using deep learning with multi-layered Neural Networks, or using histograms of oriented gradients. Such techniques may also include, e.g., local binary point (LBP) cascades or Haar cascades. For example, in one embodiments, the processor(s) are configured to use an LBP cascade to detect faces in captured images.

Once the faces in an image are detected, the processor can then count the number of faces that have been detected in a given image.

The count of faces can then be transmitted to a remote processor (such as a processor on a mobile device, a processor on a remote server, etc.). In some instances, the one or more processors transmits data that includes not only a count, but an identification code for the advertisement being displayed. In some instances, the one or more processors transmits data that includes not only a count and an identification code for the advertisement being displayed, but also includes a geographic location identifying a location which a given image was taken and/or a geographic location of a given number of faces that were counted. That is, the data may have one or more bytes indicating a GPS location, and one or more bits indicating the number of faces counted in an image counted at that GPS location. The data being transmitted may also include other information, such as orientation of the camera, speed of the vehicle, etc. In some embodiments, the one or more processors transmits data that also includes one or more captured images. In some embodiments, each transmitted image is stored on a remote server and can be viewed later, e.g., to verify a given count is accurate. In preferred embodiments, any image stored on the display device is deleted once it has transmitted the image, or all information related to the image if no image is transmitted.

### Display Screen

The display device (10) also contains a display screen (20), which is operably connected (25) to at least the one or more processors (11). The processor(s) (11) are configured to send images to the display screen, and the display screen is configured to receive those images from the one or more processors.

The display screen (20) may be any known display technology, including but not limited to, LED, OLED, LCD, or e-paper. In some embodiments, the display screen is capable of rendering up to 1080 p, 4 k, 5 k, 6 k, or 8 k resolutions.

While the maximum size of the display limited merely by what can legally be attached to a vehicle, in some embodiments, the display may have a maximum diagonal display length of x, where 20 inches ≥ x ≥ 30 inches. In some embodiments, the display may have a maximum diagonal display length of x, where x ≤ 25 inches, ≤ 23 inches, ≤ 21 inches, ≤ 19 inches, ≤ 17 inches, ≤ 15 inches, ≤ 13 inches, ≤ 11 inches, ≤ 9 inches or ≤ 7 inches, and where x ≥ 5 inches, ≥ 7 inches, ≥ 9 inches, ≥ 11 inches, ≥ 13 inches, ≥ 15 inches, ≥ 17 inches, or ≥ 19 inches, or any combination thereof.

While the aspect ratio can be any appropriate aspect ratio, in some embodiments, the aspect ratio of the display is greater than or equal to 4:3 and less than or equal to 16:9. In some embodiments, the aspect ratio is between 17:10 and 16:9.

While the number of pixels on the display can be any technically feasible number of pixels, in some embodiments, the number of pixels on the display is less than 700,000. In some embodiments, the number of pixels on the display is between 300,000 and 700,000. In some embodiments, the number of pixels on the display is greater than 700,000. In some embodiments, the number of pixels is between 1,000,000 and 3,000,000. In some embodiments, the number of pixels is greater than 3,000,000 pixels.

### Camera

The display device (10) also contains a camera (30), which is operably connected (35) to at least the one or more processors (11). The camera is configured to capture one or more images and send each image to the one or more processors for various image processing techniques. In preferred embodiments, the camera (30) comprises a CMOS image sensor. In preferred embodiments, the camera (30) comprises at least a 1-megapixel (MP) image sensor, a 2MP image sensor, a 4MP image sensor, an 8MP image sensor, or a 12MP image sensor.

In some embodiments, the camera (30) captures images periodically, every x seconds, preferably where 0.1 seconds ≥ x ≥ 5 seconds, and more preferably 0.1 seconds ≥ x ≥ 1 seconds. That is, the camera can be configured to capture a first image, then have a predetermined delay period, and then capture a second image, where that delay is between, e.g., 0.1 seconds and 1 second.

In some embodiments, the period of time between image captures is predetermined and fixed. In other embodiments, the frequency that an image is captured is determined by the speed at which the camera is moving and/or the field of view (FOV) of the camera. For example, when comparing a camera with one FOV with a camera with a wider FOV, the camera with the narrower FOV may be required to capture images more frequently than the camera with the wider FOV. Similarly, when comparing cameras on two cars, one moving faster than the other, the car moving faster may be required to capture images more frequently than a slower car. camera with one FOV, and a camera with the camera may be required to take capture images more frequently than if the camera has a wide FOV.

### Wireless Communication Transceiver

The display device (10) also contains a wireless communication transceiver (40), which is operably connected (45) to at least the one or more processors (11). In preferred embodiments, the wireless communication transceiver (40) is a Bluetooth transceiver. In certain embodiments, other protocols may be used, including, but not limited to: various 802.x wi-fi protocols, including 802.11 a, b, g, n, ac, and/or ax, 2G, 3G, and 4G cellular, LTE protocols, ANT or ANT+, or BLE.

### Power

The display device (10) will require power, which requires some power circuitry (50) capable of ensuring the various components on the device have the appropriate current at the appropriate voltage. In FIG. 2, the circuitry is shown as being operably connected (55) only to the one or more processors (11), but one of skill in the art will recognize that other configurations may be used. In some embodiments, the power circuitry (50) is operably connected to a removable and/or rechargeable battery (not shown) and/or a solar cell (not shown). When a battery is used, the battery is typically a readily removable battery, is preferably a rechargeable battery, and more preferably a rechargeable lithium ion battery. In some embodiments, the power circuitry (50) may be configured to allow a solar cell to recharge the battery, or allow, using an adapter, the battery to be charged from, e.g., a home electrical outlet.

In preferred embodiments, the circuitry (50) is configured to connect to a vehicle’s auxiliary power outlet. In some embodiments, the connection from the power circuitry (50) to the auxiliary power outlet is via a cord (57) that connects a power connection (56) on the device to a plug (59) adapted to connect to the vehicle’s auxiliary power outlet (not shown). The power circuitry (50) may or may not include a switch (58) capable of powering on or off the display device. The switch in FIG. 2 is shown as being on the cord (57), but as will be understood by those of skill in the art, the position of the plug may be in any other appropriate location, that a user would be capable of accessing the switch.

### Housing

The display device (10) may also include an outer casing or housing (70), protecting some or all of the components of the display device (10), while still allowing the display (120) to be seen from the outside, and allowing the camera to capture images.

In some embodiments, the housing may have an external height ≥ 5 inches, ≥ 7 inches, ≥ 9 inches, ≥ 11 inches, or ≥ 13 inches, and ≤ 15 inches, ≤ 17 inches, ≤ 19 inches, ≤ 21 inches, ≤ 23 inches, ≤ 25 inches, or any combination thereof. In preferred embodiments, the height is between 11 inches and 17 inches.

In some embodiments, the housing may have an external width ≥ 15 inches, ≥ 17 inches, ≥ 19 inches, or ≥ 21 inches, and ≤ 23 inches, ≤ 25 inches, ≤ 29 inches, ≤ 31 inches, ≤ 33 inches, ≤ 35 inches, or any combination thereof. In preferred embodiments, the height is between 19 inches and 25 inches.

In some embodiments, the housing may have an external thickness ≥ 1 inches, ≥ 1.5 inches, ≥ 2 inches, or ≥ 2.5 inches, and ≤ 3 inches, ≤ 3.5 inches, ≤ 4 inches, ≤ 4.5 inches, or ≤ 5 inches, or any combination thereof. In the most preferred embodiments, the thickness is less than 3 inches.

### Other Components

In some embodiments, the display device (10) may optionally include other components (60) which are operably connected to the one or more processors (11).

In some embodiments, the other components (60) comprise one or more indicators are visible on at least one outer surface of a housing for the display device (10). In preferred embodiments, the indicator light is on an outer surface that a driver of a car can see while the display is facing outward.

In some embodiments, the other components (60) include one or more connections capable of transferring data, such as USB, ethernet, or other similar connections.

In some embodiments, the other components (60) includes a GPS chip.

In some embodiments, the other components (60) includes one or more sensors. For example, the device may contain an accelerometer, gyroscope and/or magnetometer, which can collect information allowing the system to determine the orientation of the device. This can be compared with GPS data from, e.g., a driver’s mobile device, to verify that the display is facing the way the driver has indicated it should be facing. For example, if the GPS indicates the car is travelling north, and the sensors in the display device indicate the display device is facing south, then the display device is not facing out of the front window. Similarly, if the display device indicates the device is facing up or down, the device is not displaying to nearby drivers or pedestrians.

### System

The device may be connected to the door directly via, e.g., adhesive, tape, bolts, magnets, or some other appropriate means known to those of skill in the art. The device may also be connected to the door indirectly by, e.g., being attached directly to a mounting block which has been mounted directly on the door via, e.g., adhesive, tape, bolts, magnets, or some other appropriate means known to those of skill in the art.

Referring back to FIG. 2, the outer housing (70) may be configured to allow to be removable attached to a location in or on the vehicle. For example, having necessary security features and attachment points for ensuring it can be mounted on a bumper, or having surfaces where the housing can be removably attached to a window, via, e.g., tape, hook-and-loop fasteners, or other similar approach.

In some embodiments, however, there may be a separate mount that is attached to a portion of the car and the display device can be inserted or connected to the mount.

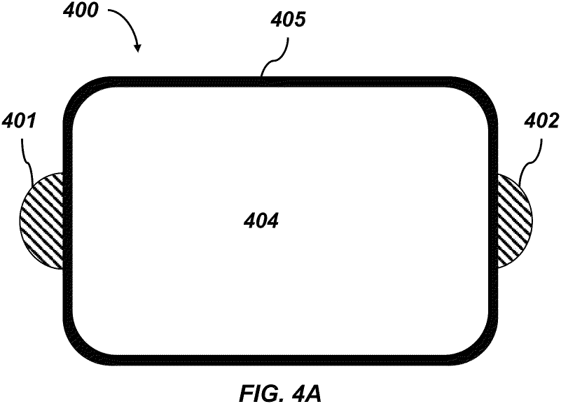

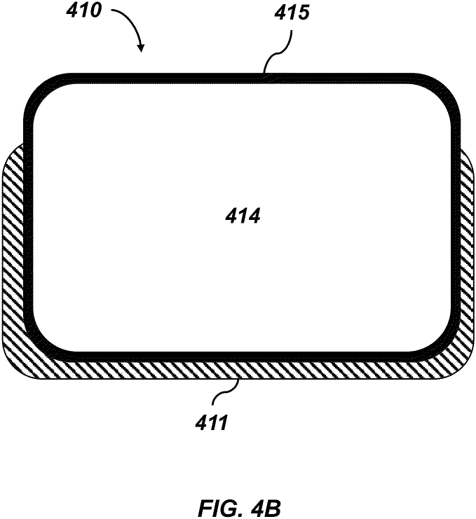

Referring to FIG. 4A, the system (400) may include a mount with two portions (401, 402) that attach to the window or bumper while allowing the display screen (404) to face outward, while the housing (405) is able to slide and/or clip into mounting portions. In some embodiments, the housing and mount are configured in a tongue-and-groove arrangement to allow the housing to be slide into place appropriately.

Alternatively, referring to FIG. 4B, the system (410) may include a mount (411) that wraps around 3 of the sides of the housing (415), still allowing the display (414) to face outwards, but only allow the device to be slid or dropped into place, and removed by lifting the housing upwards out of the mount.

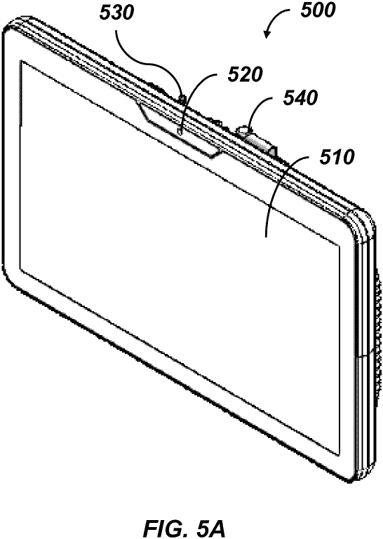

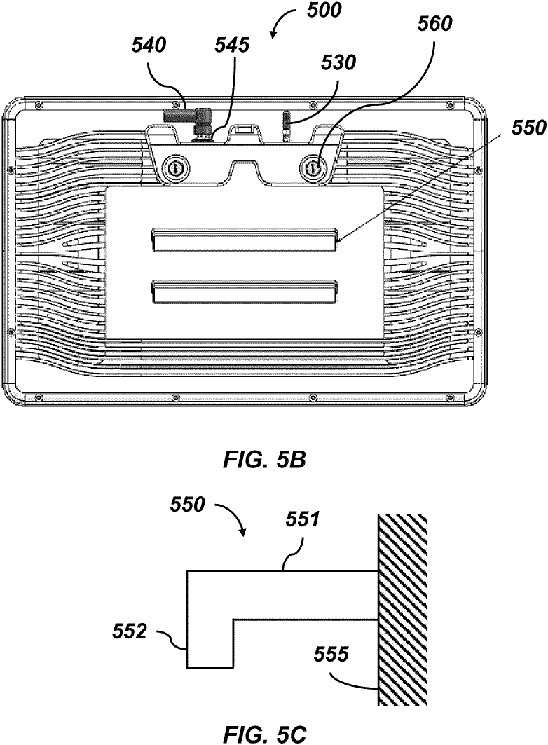

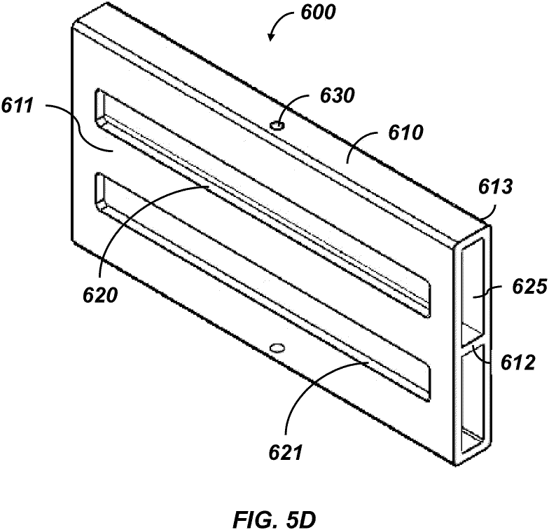

Another alternative embodiment can be seen with reference to FIGS. 5A-5D. In FIG. 5A, an isometric view of a display device (500) is shown, and FIG. 5B shows a rear view of the display device (500). These views illustrate one embodiment of a display device comprising a front-facing display screen (510), a front-facing camera (520), a wireless/Bluetooth transceiver (530) on the back of the device near the top edge, and a power cord (540) connecting to a power connection (545) on the back of the device also near the top edge. Venting ports (560) are also present on the back of the device, configured to allow the heat generated by the onboard electronic circuitry (such as an onboard processor) to keep eliminate hot air, without allowing rain, snow, etc., to easily enter into the system.

The two-part mounting system can be seen in reference to FIGS. 5B-5D. This system is designed such that a component of the display device (see FIG. 5B) can be removably attached to a separate mounting block (FIG. 5D). The display device (500) includes one or more mounting brackets (550). Preferably, there are at least two mounting brackets. More preferably, there are two mounting brackets. The mounting brackets are preferably at least 30% of the width of the display device, and less than 50% of the width of the device. When multiple mounting brackets are present, the mounting brackets are preferably offset vertically, and parallel to each other. The mounting brackets (550) are preferably an “inverted L” shape (see, e.g., FIG. 5C), having a horizontal portion (551) extending away from a surface (555) of the display device, and a vertical portion (552) that extends vertically from an end of the horizontal portion (551), and preferably extending vertically downward, towards the bottom of the display device. The mounting bracket is preferably a molded portion of display device housing, or, alternatively, is otherwise securely fixed to the display device via, e.g., welding, bolts, etc.

The mounting block (600) is generally a three-dimensional structure, having a top surface (610), and a front surface (611) that is separated from a back surface (613) by a fixed distance, forming a substantially open interior cavity (625). The back surface (613) is intended to be affixed to a surface of a vehicle, such as via adhesive, magnetically, etc. The mounting block may have supports (612) that run through the open interior cavity (625), separating the cavity into separate, smaller cavities. The front surface may define one or more openings (620, 621) extending through the front surface to the open interior cavity, each of which is preferably sized to accommodate only a single mounting bracket (550). The mounting block is preferably designed such that, an opening (620) and the internal cavity (625) define a roughly “C” shaped open volume of space, which the mounting bracket (550) can be inserted into, and the vertical portion (552) hooks into the “C” shaped volume of space, and prevents the display device from moving horizontally. Holes (630) in at least a top surface (610) of the mounting block (600) allow a screw, cotter pin, or other fastening device to be used, once the mounting bracket has been inserted into the mounting block, to keep the mounting bracket from moving, keeping the two components from being separated (e.g., to prevent the display device from falling off while the vehicle is driving).

In some embodiments, the mounting block has a height ≥ 2 inches, ≥ 3 inches, or ≥ 4 inches, and ≤ 8 inches, ≤ 10 inches, or ≤ 12 inches, or any combination thereof. In preferred embodiments, the height is between 4 and 8 inches.

In some embodiments, the mounting block has a width ≥ 6 inches, ≥ 8 inches, or ≥ 10 inches, and ≤ 14 inches, ≤ 16 inches, or ≤ 18 inches, or any combination thereof. In preferred embodiments, the height is between 8 and 14 inches.

In some embodiments, the mounting block has a thickness ≤ 2 inches, ≤ 1.75 inches, ≤ 1.5 inches, or ≤ 1.25 inches. In preferred embodiments, the thickness is ≤ 1.25 inches.

As these devices may be attached to the sides of vehicles, and thus may extend outwards from the sides of those vehicles, the combined thickness of the mount and display device, when the display device is inserted into the mount, is preferably as small as possible. In some embodiments, the combined thickness of the two components, when the display has been attached to the mounting block, is ≤ 1 inch, ≤ 0.75 inches, ≤ 0.5 inches, or ≤ 0.25 inches greater than the thickness of the display device itself. Preferably, the combined thickness is ≤ 0.25 inches greater than the thickness of the display device itself. That is, if the display device by itself is 2 inches thick, the combined mounted display device thickness is less than 2.25 inches.

### Mobile Device

Referring back to FIG. 1A, the system (100) also includes a mobile device (110) paired to the display device (10). The mobile device may be, but is not limited to, a smartphone, smart watch, smart glasses, tablet, laptop, etc. The mobile device should be capable of communicating wirelessly (115) with a remote server (120) and the display device (10). As will be understood by one of skill in the art, because of this communication link between the remote server and the display device, the mobile device will typically be capable of downloading content, uploading usage data, and other similar functions, including receiving and sending updates, control signals, and other similar functions, as appropriate.

The mobile device should have an application stored on non-transitory computer readable media, the application containing instructions that (at a minimum), when executed by processor(s) on the mobile device, cause the mobile device (110) to receive an advertisement from the remote server (120) , and send the advertisement to the display device (10).

### Ad Store

Referring again to FIG. 1A, in preferred embodiments, the mobile device (110) is configured to wirelessly connect (115) to one or more processors located on a remote server (120) (e.g., an “Ad Store”), such as cloud-based server(s). The Ad Store contains the advertisements themselves as well as related data necessary for matching ads with drivers. The related data can include, but is not limited to, a company name or identifier, an advertisement identifier (e.g., a 16-, 32-, or 64-bit number identifying this specific advertisement), a company, product, and/or service name, the industry category or code associated with the company, product, and/or service, location data for where the advertisement is intended to be displayed, start and stop dates for the advertisement, and pricing data.

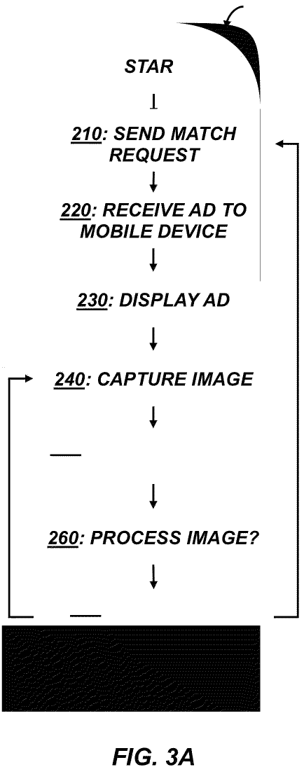

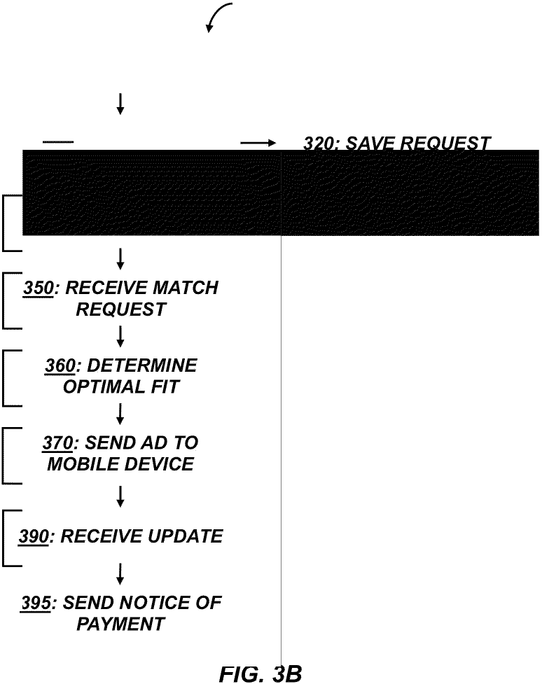

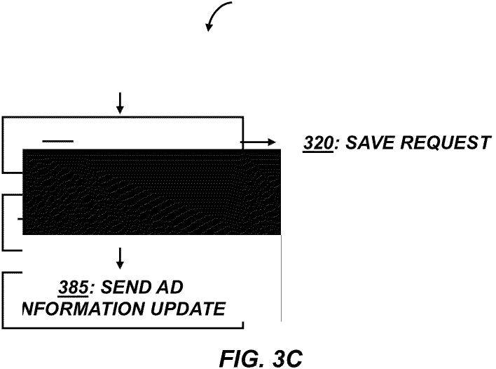

Referring to FIG. 3B, in one embodiment of a disclosed method for an Ad Store (300), when a company wishes to add an advertisement to the Ad Store, that company can, e.g., use a website or app to send an ad request to the Ad Store, where the company would upload an image or video to be displayed and target or maximum number of impressions they wish to pay for. The company could also add additional filters for who their ad would be available to, based on, e.g., location, weather, dates, times, type of car, model of display device, age, sex, etc. For example, a company can purchase 1000 impressions only to be shown at a certain geographic location or region. The Ad Store / remote server (120) would receive this ad request (310), and save the request (320), typically in a database, along with an associated advertising request identifier. Typically, multiple ads are on the store, and thus the ad store must be configured to receive a plurality of such advertiser requests.

Separately, a user’s application (e.g., an application run by an individual whose mobile device would be connected to a display device (10)) is preferably configured to allow a user to define a profile for themselves that relates to which advertisements they would want to be displayed on their display device(s). The user profile comprises at least one characteristic or preference, which can include, but are not limited to, type/make/model of vehicle being driven, type of display device being used, favorite or least favorite industries, age, sex, a whitelist or blacklist of specific companies, etc. In some embodiments, the profile is uploaded (330) and saved (340) on a remote server (e.g., the Ad Store) along with an associated user profile identifier, to minimize the amount of data required to be transmitted by the mobile device when requesting ads from the Ad Store.

The mobile device will, at some later point in time, send a request for a matching advertisement (350). This may be done automatically by the mobile device, or, upon specific request of the user. Preferably, the application defaults to this step being managed by the mobile device, as this will minimize the likelihood of a driver driving but not displaying an advertisement (and thus would not be paid).

Once the Ad Store has received the user request for a matching advertisement, the Ad Store will compare user information from the request itself (which may include, e.g., user preferences, filters, location data, weather, etc.), any user profile information that has been stored for that user, and some or all of the ad requests that have been stored.

Using techniques known to those of skill in the art, the Ad Store will make a determination, automatically, as to which of the Advertisements is the optimally fit ad (360) that can be displayed on the display device, based on the available user information from the request and/or profile. This is typically done based on a comparison of the user profile with the data associated with each advertisement, and possibly other information such as GPS location, date, time, or weather. The displayed advertisement is, ideally, the highest-paying advertisement that best fits the various matched characteristics for the particular display device, location, vehicle, etc. The advertisement will, at some point in time, be sent to the mobile device (370) for display, preferably with a target number of impressions to be made by the mobile device. In some embodiments, the target number of impressions is the maximum number of impressions the advertiser wishes. In some embodiments, the target number of impressions is a portion of that number.

In FIG. 3B, it is shown as happening after the determination of the optimal fit. While this is a preferred embodiment, the ad may be sent at any time. In one embodiment, all images may be pre-downloaded to a device, e.g., at a user’s home, to avoid cellular data transfer costs.

That advertisement is then sent to the mobile device (370), which then sends the ad to the display device. In some embodiments, the advertisement received from the remote server is based on filters selected by a user of the application, such as filters for limiting which advertisements can be presented, increasing categories of advertisements that are preferred, or a combination thereof. Said differently, the ad store makes its determination based on those filters, which are sent along as part of the matching request.

In preferred embodiments, the mobile device sends a request to a remote Ad Store, and the Ad Store completes the matching process. However, in other embodiments, as seen in FIG. 3C, the Ad Store process (301), continues to handle the ad requests from Advertisers (310) and saves those requests (320), but also receives update requests (380) from mobile devices, upon which time the Ad Store sends (385) some or all of the information associated with ads to a mobile device. The processor on the mobile device then determines the optimal fit (360), and sends the appropriate ad to the display device.

Referring back to FIG. 3B, at some point after the display device has captured an image, the remote server will receive updates (390) from the mobile device, indicating a number of faces counted while a given advertisement was displayed, and a geographic location of the faces.

Based on a predetermined cost for a given number of impressions (e.g., cost per thousand impressions (CPM)), the remote server will transfer a payment to the user based on the number of faces counted and that cost for a given number of impressions. Note that “transfer a payment” may simply not be an actual payment, but rather updating a user’s account on the remote server to allow the user (at a later time) to transfer money from the user account on the remote server to, e.g., the user’s personal bank account, or any other approach, known to those of skill in the art, updating or indicating an obligation for the user to be paid for the work performed. In some embodiments, payments are made every time an update is sent. In some embodiments, payments are made every time a certain number of impressions have been made (every 1,000; every 5,000, or every 10,000 impressions, for example). Further, the as multiple users may be displaying the same advertisement simultaneously, the user may be paid whenever the total number of impressions reaches a given amount, even if the user has only acquired a portion of those impressions. For example, if the system is configured to pay users a fixed amount for 10,000 impressions, and a first user acquires 5,000 impressions, a second user acquires 3,000 impressions, and a third user acquired 2,000 impressions, the remote server will eventually transfer an amount of money to the three users that will be divided up such that the first user receives 50% of the fixed amount, the second user received 30%, and the third user receives 20%.

In some embodiments, when multiple display devices are displaying the same advertisement, when the maximum number of impressions the advertiser is willing to pay for has been made, the system sends an update to each mobile device that is displaying that advertisement indicating the ad should stop displaying, and may optionally send along a second ad to be displayed as if the user had sent a second matching request.

In some embodiments, processors are the remote server are configured to store some or all of the data sent to it from the display device and/or mobile device in one or more databases. The processors are also configured to aggregate and/or manipulate the data, preferably to allow users or advertisers to gain insights from the stored data.

In some embodiments, users or advertisers can check locations of where their devices have made impressions, or where impressions of their advertisements have been made. They can do so by sending a request to the remote servers for the geographic distribution of counted faces for a given user, a given advertiser, or a given advertiser request (such as a specific advertisement identifier or company identifier). In one embodiment, the remote servers receive this request, and then generate a heat map of the counted faces based on the geographic location received for each face. Any known technique for generating the heat map can be utilized. This heat map can then be displayed to the users or advertisers as appropriate. Preferred heat maps display at least a portion of a road map overlaid with different colored areas, each color representing a range of impressions made while an advertisement was being displayed.

In some embodiments, the remote servers are updated in real time. At any point, a mobile device can send its location and driver info to the server and request an ad, and the server will find an ad that fits that location and driver info. In some embodiments, the mobile device will ask for one or more new ads any time the mobile device determines it is nearing the end of a playlist of one or more currently running ads. In some cases, this time period between requests for new ads could be as often as, e.g., every 30 seconds, or for as long as advertisers are willing to pay. For example, if an advertiser is willing to pay for a single ad to be displayed continuously for 15 minutes, the mobile device may only need to request new ads after 14.5 minutes.

### Mobile Device Application

In operation, the mobile device will typically run an application in order to manage the advertisement process. Referring to FIG. 3A, some embodiments of the process begins with sending a match request (210) to the Ad Store. As described previously, the request may contain information relevant to the matching process, including, but not limited to, user-selectable filters capable of indicating preferences or requirements for the ads to be displayed, location data, or weather. In some embodiments, a user of the application can select a specific advertisement received from the remote server, and the “matching” process simply assures that the advertisement is still available for the user to choose, and that the user information matches the advertisement requirements (e.g., that the user is in a location that the advertiser wishes the ad to be displayed within).

Once the Ad Store has made a determination as to a matching ad, the ad is then received (220) by the mobile device. The application then sends the image or video associated with the ad to the display device, causing it to be displayed (230). While the ad is being displayed, the display device will capture images (240), determine if faces are present, and, if so, make a count of the number of faces. The application will then receive, from the display device, at least a count of the number of faces (250). At this time, a geographic location (such as a GPS location, a town or city name, or some other identification of a geographic location) may be associated with each face. In some embodiments, it does this by associating a geographic location with the count of faces. In some embodiments, the mobile device may have a database of geographic locations, number of counted faces, and an identification code associated with a particular advertisement that was being displayed when the faces were counted at that location. In some embodiments, the system is configured to associate a geographic location with code representing each individual face identified by the system. Said differently, in some embodiments, a vector representing the image features of each given face as saved, along with an identifier representing a geographic location, and an advertisement being displayed when the face was captured.

In some embodiments, the one or more processors of the display device are configured to instruct the camera to capture one or more images while a first advertisement is being displayed on the display screen and send the one or more images to the mobile device. In instances where an image is sent to the application from the display device, the application may process the image (260) in some fashion. The processing includes, but is not limited to, saving it, reformatting it, transmitting it to a remote server, and/or performing additional image processing techniques on the image, such as cropping or manipulating the image to provide only the detected faces. In some cases, using known techniques, facial recognition may be performed with other images stored on the device, and it will be determined if the same face appears in multiple images. In other embodiments the images are sent to the remote server for additional processing. In some embodiments, the images are deleted after a period of time, such as after 5 minutes, after 2 minutes, after 1 minute, after 30 seconds, or after 10 seconds.

The received count is then added to a running total number of faces counted while the ad has been displayed (i.e., the number of “impressions”), and that running total is then compared to a threshold (270). Said differently, the mobile device is configured to count the number of faces present in all images captured while the first advertisement is being displayed. If the threshold has not been reached, the application waits for another image to be captured and the count to be incremented. If the threshold has been reached, the application preferably sends a match request for a new ad to be displayed. The threshold may be a target number of impressions. That is, if an advertiser has indicated the ad should be shown to 1,000 people, then threshold may be 1,000 people. In some embodiments, the threshold is based on the rate at which impressions have been made recently in the previous 5 seconds, 4 seconds, 3 seconds, 2 seconds, or 1 second. For example, if the advertiser is paying for 1,000 impressions (or only 1,000 more impressions than has already been displayed), and the camera is capturing 100 faces per second, then the entire 1,000 impressions could be determined as needing 10 seconds of display time. If the process of matching and downloading a new ad is determined or defined (which may be predetermined and hardcoded, or may be based on current data transfer rates, etc.) as taking 2 seconds, then the mobile device may determine a threshold has been met 8 seconds after displaying the advertisement. Although it will keep displaying the ad until 1,000 impressions has been met, it may request a new matching advertisement the threshold is met at 8 seconds, such that once the 1,000 impressions have been completed, a new advertisement is ready to start being displayed immediately. In other embodiments, the threshold used to determine when to send a request for another matching advertisement is when the number of counted faces is at the target number of faces ± 20%, ± 15%, ± 10%, or ± 5%.

At some point during this process, which may be once the total number of faces counted matches the target number of faces to be displayed, or any other appropriate point in time during the process, the mobile device will send an update (280) to the remote server. The update will typically include sending data to the remote server, comprising a count of the number of faces the advertisement has been displayed to, geographic locations of the counted faces, and the advertisement(s) being displayed to those faces. The count may be the count of each individual image received from the camera, the running count since the previous update, the total number of impressions since the advertisement began displaying on a display connected to the mobile device, or some other similar count that allows the Ad Store to ensure the user is paid appropriately for the impressions their display device has captured.

At some point in time after the remote server (120) has received an update (280), the system will receiving data comprising an indication of a payment to a user based on the counted number of faces (including, as described above, any count associated with the number of faces, such as the total number of faces counted while the advertisement was displayed, or the number of faces captured since the previous update was sent, etc.). In some embodiments, such payment and notice are provided after every update. In some embodiments, such payment and notice are provided only after the target number of impressions has been made.

In some embodiments, any time a new ad is pushed to the display, the display sends information regarding the previous ad to the mobile device. The information sent includes a count of how long the ad was running and how many faces it counted during that run time.

In some embodiments, the display sends data (e.g., how fast it’s moving in what direction) from its IMU (inertial measurement unit), assuming it has the appropriate additional sensors to the mobile device on request. In some embodiments, the mobile device will make such requests randomly and/or periodically, and compare the response data from the mobile device’s sensors, e.g., to prevent cheating, to identify a sensor failure, etc. In some embodiments, such request and comparisons occur at least once every 5 minutes, once every 4 minutes, once every 3 minutes, once every 2 minutes, or once a minute. In some embodiments, this requested device sensor data and/or mobile device sensor data is only transmitted to the remote server if there is a mismatch between the mobile device and the display. In embodiments where the display does not have a GPS built in, the ad’s locations are determined by the GPS in the mobile device.

In some embodiments, the mobile device is configured to relay the ad data returned from the device to the server. In some embodiments, the mobile device is configured to also do additional processing (such as the requests and comparisons of IMU data), and may inject additional data to be sent to the server (e.g., location data), or may send such additional data separately, such as on request from the server.

Those skilled in the art will recognize or be able to ascertain using no more than routine experimentation, many equivalents to the specific embodiments of the invention described herein. Such equivalents are intended to be encompassed by the following claims.

What is claimed:

1. A display device for mobile advertisement, comprising:
one or more processors;
a display screen configured to receive images from the one or more processors; and
a camera configured to capture images and send the images to the one or more processors; and
a wireless communication transceiver operably connected to the one or more processors;
wherein the display device is adapted to wirelessly communicate with a mobile device, and
wherein the display device is configured to be placed in a location within or on a vehicle such that the display screen can be seen and read by a person outside the vehicle.

2. The display device according to claim 1, further comprising one or more sensors.

3. The display device according to claim 1, wherein the display screen has a diagonal viewing dimension of between 20 and 30 inches.

4. The display device according to claim 1, wherein the one or more processors are configured to:
receive an image from the camera;
detect one or more faces in the image;
determine a count of detected faces in the image;
delete the image; and
transmit the count of the one or more faces in the image to at least one remote processor.

5. The display device according to claim 1, wherein the display device is configured to:
capture a first image; and
after a first delay, capture a second image,
wherein the first delay is between 0.1 seconds and 1 second.

6. An advertising system, comprising:
the display device according to claim 1; and
a mobile device paired to the display device, the mobile device running an application capable of communicating with a remote server, the mobile device configured to receive an advertisement from the remote server, and send the advertisement to the display device.

7. The advertising system according to claim 6, wherein the advertisement received from the remote server is based on filters selected by a user of the application, wherein the filters include filters for limiting which advertisements can be presented, increasing categories of advertisements that are preferred, or a combination thereof.

8. The advertising system according to claim 6, wherein the display device is operably connected to an exterior of a passenger side door of a car.

9. The advertising system according to claim 6, wherein the one or more processors are configured to instruct the camera to capture one or more images while a first advertisement is being displayed on the display screen and send the one or more images to the mobile device.

10. The advertising system according to claim 6, wherein the mobile device is further configured to count the number of faces present in all images captured while the first advertisement is being displayed.

11. The advertising system according to claim 6, wherein the mobile device is further configured to determine if the same face is present in more than one image.

12. The advertising system according to claim 6, wherein the mobile device is further configured to associate a geographic location with each face.

13. The advertising system according to claim 6, wherein a user of the application can create a user profile, and the system is configured such that the advertisement received from the remote server is based on the user profile.

14. The advertising system according to claim 6, wherein a user of the application can select the advertisement received from the remote server.

15. A method for mobile advertising, comprising:
sending a request for a first matching advertisement;
receiving data comprising an advertisement to be displayed and a target number of faces;
causing a display device to display the advertisement;
capturing images with a camera, counting the number of faces in the captured images while the advertisement is being displayed, and associating a geographic location with each face;
sending data comprising the counted number of faces to the remote server and geographic locations of the counted faces; and
receiving data comprising an indication of a payment to a user based on the counted number of faces.

16. The method according to claim 15, further comprising sending a request for a second matching advertisement when the number of counted faces is at the target number of faces ± 10%.

17. A system for displaying mobile advertising, comprising:
one or more processors configured to:
receive a plurality of advertiser requests, each advertiser request comprising an image or video to display, a target location, and a maximum number of people that should see the image or video;
store each of the plurality of advertising requests with an associated advertising request identifier;
receive a user profile from a mobile device, the user profile comprising at least one characteristic or preference of a user;
store the user profile and an associated user profile identifier;
receive a user request for a matching advertisement;
determine which of the plurality of advertiser requests is an optimal fit for the user request, based on the at least one characteristic or preference, a user location, user filters, the target location, or a combination thereof; and
send the image or video from the optimally fitting advertiser request to the mobile device.

18. The system according to claim 17, wherein the one or more processors are further configured to:
receive an update from the mobile device indicating a number of faces counted and a geographic location of each face; and
transfer a payment to the user based on the number of faces counted.

19. The system according to claim 18, wherein the one or more processors are further configured to:
receive a request for the geographic distribution of counted faces for a given advertiser request; and
generate a heat map of the counted faces based on the geographic location received for each face.

20. A method for displaying mobile advertising, comprising the steps of:
receiving a plurality of advertiser requests, each advertiser request comprising an image or video to display, a target location, and a maximum number of people that should see the image or video;
storing each of the plurality of advertising requests with an associated advertising request identifier;
receiving a user profile from a mobile device, the user profile comprising at least one characteristic or preference;
storing the user profile and an associated user profile identifier;
receiving a user request for a matching advertisement;
determining which of the plurality of advertiser requests is an optimal fit for the user request, based on the at least one characteristic or preference, a user location, user filters, the target location, or a combination thereof; and
sending the image or video from the optimally fitting advertiser request to the mobile device.

21. The method according to claim 20, further comprising:
receiving an update from the mobile device indicating a number of faces counted and a geographic location of each face; and
transferring a payment to the user based on the number of faces counted.

22. The method according to claim 21, further comprising:
receiving a request for the geographic distribution of counted faces for a given advertiser request; and
generating a heat map of the counted faces based on the geographic location received for each face.
